(19) United States
(12) Patent Application Publication
(10) Pub. No.: US 2010/0035080 A1
(43) Pub. Date: Feb. 11, 2010

(54) Corrosion resistant laminated steel

(75) Inventors: David R. Sigler, Shelby Township, MI (US); Robert B. Ruokolainen, Livonia, MI (US); Guangling Song, Troy, MI (US); James G. Schroth, Troy, MI (US)

Correspondence Address: General Motors Corporation;c/o REISING, ETHINGTON, BARNES, KISSELLE, P.C., P.O. BOX 4390, TROY, MI, 48099-4390, US

(73) Assignee: GM GLOBAL TECHNOLOGY OPERATIONS, INC., DETROIT, MI (US)

(21) Appl. No.: 12/333,390

(22) Filed: Dec. 12, 2008

Related U.S. Application Data
(60) Provisional application No. 61/032,450, filed on Feb. 29, 2008.

(51) Int. Cl. B32B 15/08

(52) U.S. Cl. 428/626

(57) ABSTRACT

Outer steel sheet-viscoelastic core laminates are often subject to corrosion in moisture-containing environments. Zinc-based alloys of aluminum, or of aluminum and magnesium, may be beneficially applied to the inner faces of the steel sheets or to both the inner and outer sheet faces. Substantially pure zinc coatings may be applied over the zinc-based alloys or over an otherwise bare outer steel sheet surface. Combinations of such zinc-based alloy coatings and substantially pure zinc coatings improve the corrosion resistance of the steel sheet-polymer core laminates while maximizing weldability and paintability.

This application claims the benefit of U.S. Provisional Application No. 61/032,450, titled “Corrosion Resistant Laminated Steel”, and filed Feb. 29, 2008.

### TECHNICAL FIELD

This invention pertains to laminated steel articles formed of thin outer steel skin sheets sandwiching a viscoelastic polymeric core material. More specifically, this invention pertains to zinc-aluminum and zinc aluminum-magnesium alloy coatings for the steel sheets for resisting corrosion, especially corrosion in moisture-containing environments.

### BACKGROUND OF THE INVENTION

Laminated steel blanks have been adapted for use in automotive vehicles. The outer steel skin sheets may have thicknesses of, for example, about one-half millimeter to two millimeters and provide the laminate with structural integrity. The viscoelastic polymeric core layer has a typical thickness of about 20 to 50 micrometers to provide sound-damping or other useful properties in the laminate. For example, these sheet laminates are shaped into vehicle body panels that reduce vehicle vibrations generating noise in the passenger compartment. Laminates with thicker cores may be used in other applications.

The steel compositions are selected for their strength and formability, and for welding or other joining practices in making the vehicle body. Since the laminates are often exposed to water and humid atmospheres the steel must be protected from corrosion. The exterior surfaces of current, commercial laminated steel products may be protected from corrosion by one or more of galvanized coatings, zinc phosphate layers, e-coat layers, and additional polymer paint coatings.

Some current versions of laminated steel consist of electro-galvanized or hot-dip galvanized thin steel sheets (˜0.5 mm) that are laminated together with a thinner, sound damping viscoelastic core. Galvanizing results in a material with about 60 g/m² (about 8.4 micrometers thick) of zinc on the exposed exterior surfaces of the steel sheets as well as the two interior surfaces. Manufacturing operations such as laminate forming, spot welding, piercing, flanging, shearing and others can cause local delamination of an outer steel layer from the polymer material. This delamination provides an opening for ingress of moisture between the laminate interior surfaces. Water can cause untimely perforation by corrosion of the laminate despite the high levels of zinc applied to the laminate's interior surfaces because the zinc layer is very reactive and can be consumed quickly on exposure to moisture since there are no additional barrier layers such as those applied to the sheet exterior. To meet vehicle customer needs and obtain longer material life, the laminate must have significantly improved corrosion resistance.

There remains a need for corrosion resistant coatings for steel laminates that accommodate forming, joining, painting and other vehicle body making operations and provide long term protection against corrosion.

### SUMMARY OF THE INVENTION

In accordance with embodiments of this invention, combinations of substantially pure zinc coatings and zinc-aluminum or zinc-aluminum-magnesium alloy coatings are applied to surfaces of thin steel sheets for use in steel laminate blanks. In one embodiment, the laminated steel sheet may include two steel skin sheets with facing surfaces bonded by a polymer core layer. The combinations of these zinc and zinc alloy coatings are used to improve the corrosion resistance of the steel sheets in contact with polymer core layers. The coatings are placed to facilitate forming of the sheet laminates into vehicle body panels and the like, and to permit their use in welding, painting, and other vehicle body making operations.

Substantially pure zinc (99⁺% Zn) coatings have been applied to iron and steel articles by hot-dipping (at about 460° C.) and lower temperature electrolytic processes to provide galvanized parts. When the zinc is applied by hot-dipping, unwanted brittle iron-zinc compounds may sometimes form on the galvanized surface. Therefore, sometimes small additions (e.g., 0.1 to 0.2 weight percent of the zinc alloy) of aluminum are added to the molten zinc to prevent the formation of the brittle compounds. The thin zinc coating (typically about 8 micrometers thick) acts as a barrier and as a sacrificial anode to resist corrosion. In practices of this invention, zinc-aluminum alloy coatings containing about two to about ten weight percent aluminum are sometimes used in combination with the substantially pure galvanized zinc coatings. These zinc-aluminum alloys may also contain about one to four weight percent (typically about three percent) of magnesium.

In preferred embodiments of the invention, the zinc-aluminum or zinc-aluminum-magnesium alloys may be applied as co-extensive coatings to one or both sides of the steel sheet before the polymeric core material is applied to one or both sheets in assembly of the laminate. Unless otherwise stated, a reference in this specification to zinc-aluminum alloy coatings is intended to include zinc-aluminum-magnesium alloy coatings. Substantially pure zinc layers may be applied over the zinc-aluminum layers or on otherwise uncoated steel sheet surfaces before or after assembly of the laminate. In various embodiments, the substantially pure zinc coating may be about one micrometer to about twenty micrometers thick. In one embodiment, the substantially pure zinc coating may be about four to about fifteen micrometers thick. Unless otherwise stated, a reference in this specification to substantially pure zinc refers to at least 99 weight % zinc, up to and including completely pure (100 weight %) zinc.

In one embodiment of the invention, zinc-aluminum alloy coatings are applied to both surfaces of each of the steel sheets, and substantially pure zinc coatings are applied over the zinc-aluminum coatings. The assembled laminate thus has two distinct coating layers on both outer steel sheet surfaces of the laminate and both inner steel sheet surfaces facing the polymeric core material. In this example, the zinc-aluminum coatings provide most of the corrosion resistance and are about 4 to 12 micrometers thick, while the outer substantially pure zinc coatings would be thinner: approximately one micrometer thick. The outer layer of substantially pure zinc located on the laminate exterior would provide improved paintability.

In a second embodiment of the invention, zinc-aluminum alloy coatings are applied to both surfaces of each of the steel sheets, but substantially pure zinc coatings are applied over the zinc-aluminum coatings only on the outer steel sheet surfaces of the laminate. Again, the zinc-aluminum coatings provide most of the corrosion resistance and would be about four to twelve micrometers thick, while the substantially pure zinc on the laminate exterior would provide improved paintability and would be thinner: approximately one micrometer thick.

In a third embodiment of the invention, a zinc-aluminum alloy coating is applied to each of the intended inner steel sheet surfaces and a relatively heavy coating of substantially pure zinc is applied to the outer surfaces of the steel laminate. The zinc aluminum coating on the inner surface provides protection of that surface and would be about four to twelve micrometers thick, while the relatively heavy substantially pure zinc coating on the laminate exterior would provide both corrosion resistance and improved paintability and would be approximately four to twelve micrometers thick.

And in a fourth embodiment of the invention, a zinc-aluminum alloy corrosion resistant coating, e.g., about eight micrometers thick, is applied to each of the intended inner steel sheet surfaces and to the intended outer sheet surfaces of the steel laminate. No substantially pure zinc coating is used in this embodiment. As in each of the above examples, the zinc-aluminum alloy may comprise, by weight, about two to six percent (even up to ten percent) aluminum, optionally about one to four percent magnesium, and the balance substantially all zinc.

A preferred usage of substantially pure zinc and/or zinc-aluminum alloy coating layers (e.g., steel sheet side locations and thicknesses) can be chosen for the steel sheet surfaces of a laminate specifically for the anticipated corrosion environment of a laminate part and the various manufacturing operations by which the part is formed, welded, painted, or the like. An outer layer of substantially pure zinc may be preferred to accommodate, for example, painting. But the zinc-aluminum alloy is utilized for improved resistance to corrosion, especially moisture-promoted corrosion.

Additional coatings may be provided over the zinc-aluminum alloy coatings and the substantially pure zinc coatings applied to the steel sheet surfaces. For example, zinc phosphate layers, e-coat layers, and polymer paint coatings may be applied to the pre-coated steel sheet surfaces, especially the outer sheet surfaces.

Other objects and advantages of the invention will be understood from detailed descriptions of preferred embodiments which follow in the text below and the drawings which are described below.

### BRIEF DESCRIPTION OF THE DRAWINGS

FIG. 1 is an oblique view of a laminated steel front-of-dash vehicle body panel. This is an illustration of a vehicle body component that may be formed of laminated steel sheet material. Although not visible in FIG. 1, the laminated steel sheet comprises two steel skin sheets with facing surfaces bonded by a viscoelastic polymeric core layer. The core layer comprises electrically conductive particles. The following drawing figures of edges of the panel illustrate corrosion-resisting coating strategies for the inner and outer surfaces of the steel sheets.

FIG. 2 is a schematic, enlarged view of a portion of an edge (at location 2 in FIG. 1) of the laminated steel panel of FIG. 1 illustrating a first corrosion protection embodiment of the invention. In FIG. 2, both inner and outer surfaces of the steel sheets are coated with a zinc-aluminum alloy layer and with a thin overlying substantially pure zinc layer.

FIG. 3 is a schematic, enlarged view of a portion of an edge (at location 2 in FIG. 1) of the laminated steel panel of FIG. 1 illustrating a second corrosion protection embodiment of the invention. In FIG. 3, both inner and outer surfaces of the steel sheets are coated with a zinc aluminum alloy layer. The outer surfaces of the steel sheets have a thin overlying substantially pure zinc layer.

FIG. 4 is a schematic, enlarged view of a portion of an edge (at location 2 in FIG. 1) of the laminated steel panel of FIG. 1 illustrating a third corrosion protection embodiment of the invention. In FIG. 4, the inner surfaces of the steel sheets are coated with a zinc-aluminum alloy layer and the outer surfaces of the sheets are coated with a relatively thick substantially pure zinc layer.

### DESCRIPTION OF PREFERRED EMBODIMENTS

Various embodiments include a new laminated steel product, such as a body panel, that displays improved corrosion resistance while maintaining sound damping, sheet formability, spot weldability, and painting properties. The corrosion resistance of polymer core laminated steel is accomplished by the arrangement of protective layers applied to the steel skin sheet material.

Various embodiments make use of certain zinc-aluminum alloys and zinc-aluminum-magnesium alloys that are devised to provide improved corrosion resistance to steel laminates while maintaining the useful properties of the laminates that permit laminate sheet blanks to be formed into body panels of complex shape, that permit other metal body parts to be welded or joined to the formed panels, and that permit such assemblies to be painted, including the use of industry-standard cathodic electrodeposition primer systems. Zinc-aluminum alloys comprising primarily, by weight, about two to about ten percent aluminum, optionally up to about four percent magnesium, and the balance substantially zinc (except for unavoidable impurities) are adaptable for this combination of requirements.

The corrosion mechanism of Zn—Al alloy coatings has been studied and is clearly understood. On the coating surface, a temporary protective aluminum oxide passive film forms first, then zinc from the coating diffuses through the aluminum oxide layer to form a corrosion product layer that may act as another corrosion barrier on the top of the aluminum oxide. The diffusion of zinc through the aluminum oxide layer is relatively slow. Thus, Zn—Al alloy coatings corrode relatively slowly. Magnesium additions up to four percent to these coatings are known to further refine the corrosion products, which can increase corrosion protection.

As suggested above, the microstructure of Zn—Al alloy coatings also helps account for its corrosion performance. There are significant amounts of beta phase (aluminum rich) in Zn—Al coatings, which are more corrosion resistant than the matrix eta phase (zinc rich). The beta phases also act as corrosion barriers after corrosion penetrates into the coating. Zinc-aluminum-magnesium alloy coatings have a different microstructure including an Al rich primary phase and a matrix of Al rich phase/Zn rich phase/Zn₂Mg intermetallic ternary eutectic structure. It is expected that the inter-granular regions may be corrosion paths. Mg in the paths may be corroded first and its corrosion products block the corrosion penetration along the paths. Accordingly, it is expected that the corrosion resistance will increase with increasing aluminum levels in the range of 2%<Al wt %<10%. The beta phase will increase gradually with aluminum content from ˜0.3 wt % to ˜10 wt %. Correspondingly, the barrier effect of this phase should become more evident. Within this range, there should be no changes in coating microstructure detrimental to the corrosion performance when using aluminum additions. For higher levels of aluminum, beyond the Al—Zn eutectic composition of six weight percent up to ten weight percent, excellent corrosion resistance has also been observed. However, with Zn—Al—Mg coatings, poor coating adhesion to steel occurs above ten weight percent aluminum.

Thus, embodiments of the invention utilize a Zn—Al layer on at least the interior skin sheet surfaces. The zinc-based layer contains from about 2 wt % aluminum up to and including about 10 wt % aluminum. Magnesium additions up to about four weight percent may also be added to the zinc-aluminum coating to further improve corrosion resistance.

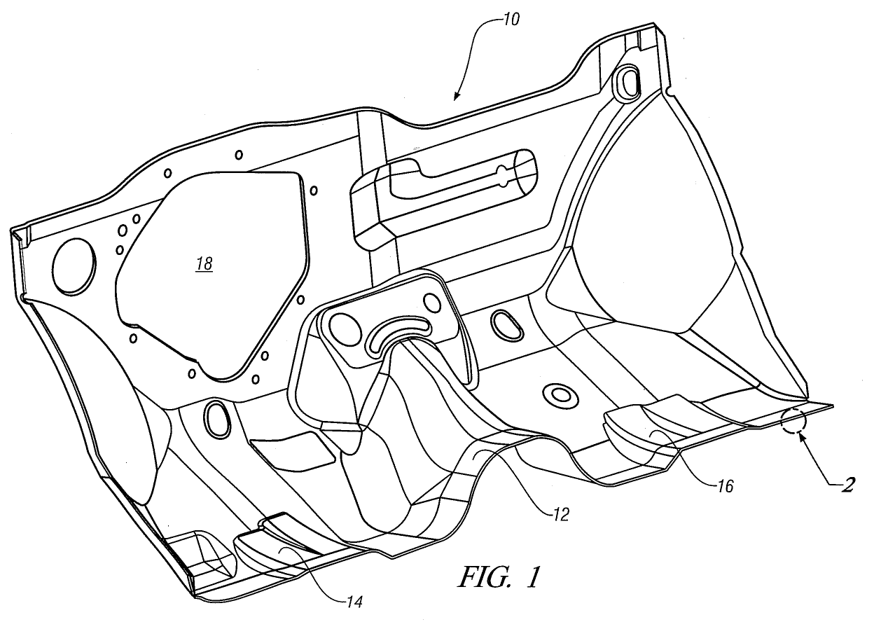

FIG. 1 illustrates a laminated steel front-of-dash panel 10 for a passenger vehicle. As illustrated, the panel is a single formed and trimmed piece of steel laminate. As seen, it is a panel of complex shape that lies below the front windshield of a vehicle passenger compartment and forward of the front doors. Panel 10 has experienced significant shaping into this body component. Panel 10 includes a tunnel shaped portion 12 to overlie vehicle drive train parts or exhaust system components and shaped portions 14, 16 for leg room for driver and passenger. Also, a portion 18 of the panel has been cut out for a steering column, not shown. Other portions of the panel have been removed for pass-through of wiring and the like.

The steel sheets forming the surfaces of the laminate are coated with substantially pure zinc and with zinc-aluminum-magnesium layers in accordance with practices of this invention before the laminate is made. After shaping a laminate blank into a panel 10 other body pieces may be welded or otherwise attached to the dash panel. And surfaces of this panel or of other steel laminate panels may be painted or provided with other coatings in the making of a full vehicle body structure.

The thicknesses of sound damping laminates used in such vehicle body applications are typically in the range of about 0.8 mm to 1.4 mm. In such steel laminates each steel skin sheet may be about 0.40 mm to 0.70 mm thick, and the viscoelastic polymer core may be about 0.025 mm to about 0.050 mm thick.

Low carbon steel skin sheet compositions are often used in steel laminate automotive body applications. Typical steel grades used include, for example, low carbon steels SAE J2329 CR4 and SAE J2329 CR5. Higher strength steels may be used when their strength properties are required. A nominal CR4 low carbon steel composition (wt %) comprises up to about 0.08% C, up to about 0.40% Mn, less than 0.025% P, less than 0.020% S, about 0.015% Al, and the balance substantially iron except for incidental impurities. Sometimes 0.01% to 0.03% of Ti and/or Nb is added. The tensile strengths of CR4 steels are typically in the range of 270 to 330 MPa, with yield strengths in the range of 140 to 180 MPa, and tensile elongations greater than about 40%. A nominal CR5 low carbon steel composition (wt %) comprises up to about 0.02% C, <0.25% Mn, <0.020% P, <0.020% S, >0.015% Al, and iron. Sometimes 0.01% to 0.03% of Ti and/or Nb is added. Tensile strengths of CR5 steels are typically greater than 260 MPa, yield strengths are about 110 to 180 MPa, and tensile elongations >42%.

The polymer core layers in steel laminates for automotive panels are often very thin, typically about 0.025 mm to 0.050 mm in layer thickness. The core layer(s) in a laminate is usually co-extensive with the facing surfaces of the sandwiching steel sheets. A typical laminate comprises two steel sheets of like shape and area with a single co-extensive polymer core-layer. But some laminates comprise three or more steel sheets with interposed polymer cores between each sheet.

The core layers may be filled with electrically conductive particles to enable electrical conductivity between the steel sheets by locally bridging the nonconductive polymer material. Such conductivity may be utilized, for example, in electrical resistance welding, electrogalvanizing, or in electrolytic application of paint or other coating layers. The conductive particles are typically sized to match the thickness of the polymer core, about 25 to 50 micrometers in automotive vehicle body laminates. Most laminates use pure Ni particles, stainless steel particles, or Fe-phosphide particles. In other laminate embodiments, Fe particles, Al particles, and/or Cu particles may be used. Typically the conductive particles make up about one to two volume percent of the polymer core material.

A number of polymer core compositions have been developed for steel laminates for automotive applications. Different families of viscoelastic core materials are known and commercially available. Some of the core materials are based on elastomer compositions such as styrene-butadiene rubber (SBR), and styrene-ethylene/butylene-styrene terpolymer (SEBS). Some are based on acrylic copolymers such as acrylic acid ester copolymer, styrene-acrylic copolymer, or its polymer blends with styrene-butadiene. Some core materials are based on polyvinyl acetate (VA), or its copolymers such as ethylene vinyl acetate copolymer or ethylene-vinyl acetate-maleic anhydride terpolymer. And some core materials are based on epoxy based block copolymer such as epoxy polyester block copolymer or epoxy polyether block copolymer.

Practices of this invention relate generally to steel laminates in which one or more combinations of zinc coatings, zinc-aluminum alloy coatings, and/or zinc-aluminum-magnesium alloy coatings have been applied to inner surfaces (i.e., facing the polymer core) and outer surfaces (i.e., opposite the polymer core) of the steel sheets. In various embodiments, a substantially pure zinc layer or coating may be applied by hot-dip galvanizing, electro-galvanizing, or the like. Following are some illustrative embodiments of the practice of the invention.

In a first embodiment, a laminate is produced with steel skin sheets that have both exterior surfaces and interior surfaces of substantially pure zinc and a Zn—Al alloy layer beneath. The final laminated product has a viscoelastic layer containing conductive particles located between the skin sheets. This laminate is particularly suitable for vehicle body applications.

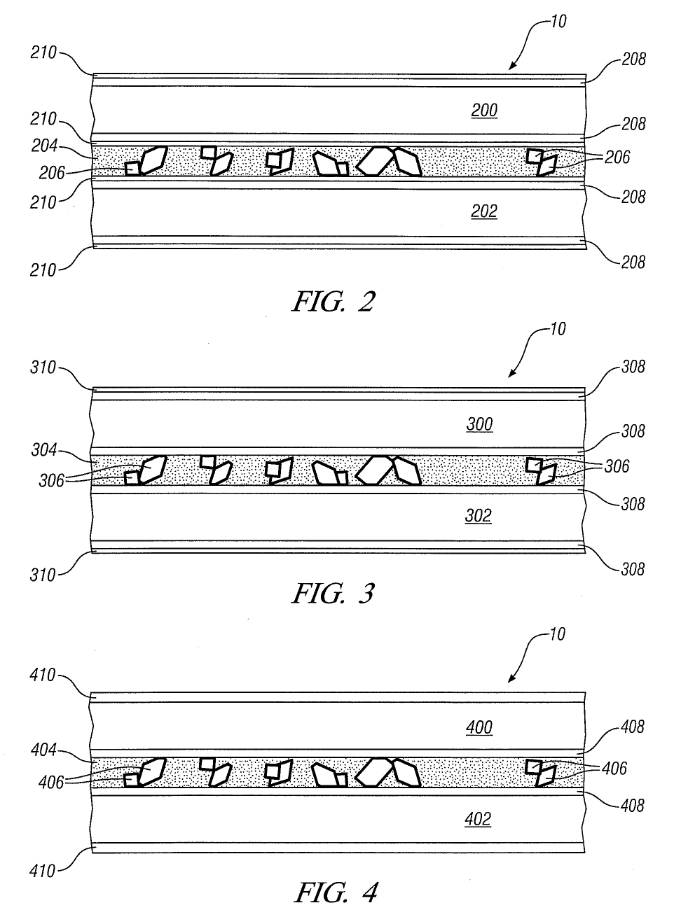

The resulting structure is shown in FIG. 2 in an edge portion (at location 2) of panel 10 of FIG. 1. In this embodiment, the panel 10 steel laminate comprises a first steel sheet 200 and a second steel sheet 202 that sandwich a viscoelastic polymer core layer 204 that is generally co-extensive with facing surfaces of steel sheets 200, 202. FIG. 2 is enlarged for purposes of illustration and not drawn to scale. In one embodiment, each steel sheet 200, 202 may be about 0.5 mm thick and the polymer core layer 204 may be about 0.04 mm thick and coextensive with identical facing surfaces of sheets 200, 202. In various embodiments, the steel sheets 200, 202 may have the same thickness or different thickness. It is seen that each steel sheet 200, 202 has a surface facing polymer core layer 204 (termed an inner surface) and a surface opposite the core layer (termed an outer surface).

Polymer core 204 comprises conductive particles 206 dispersed in an amount to provide suitable electrical conductivity through the usually non-conductive core material and between the inner surfaces of the sheets 200, 202. Typical conductive particles include copper, iron, iron-phosphides, stainless steel, aluminum, and preferably nickel. These would be preferably sized to span the gap (here about 0.04 mm, about 40 micrometers) between the sheets 200, 202 (many particles touching each facing sheet) that is formed by the viscoelastic core during the laminating process.

In this embodiment, both inner and outer surfaces of both steel sheets 200, 202 are coated with a layer 208 of zinc-aluminum alloy. In this example, the zinc aluminum alloy comprises about 4 weight % aluminum and 96 weight percent zinc. Layer 208 may be about 0.004 mm to about 0.012 mm thick. Thus, laminate 10 comprises four zinc-aluminum alloy layers 208. In various embodiments, each layer 208 may have the same thickness or different thickness. Each aluminum-zinc layer 208 is coated with a thin substantially pure zinc galvanized layer 210 that may be about one micrometer thick. In various embodiments, each layer 210 may have the same thickness or different thickness. The substantially pure zinc galvanized layers 210 on the interior sides of steel sheets 200, 202 contact polymer core layer 204 (and conductive particles 206) and the zinc galvanized layers 210 on the exterior steel sheet faces of the panel laminate 10 are exposed to the panel environment.

In this embodiment, the exterior substantially pure zinc layers can be used to provide painting performance, including the use of high-voltage electrodeposition processes, similar to that of zinc-coated steel sheet, and to provide good lubricity for forming. In addition, the Zn—Al alloy layer beneath each substantially pure zinc layer on the interior surfaces provides improved corrosion protection compared to a single substantially pure zinc galvanized coating. Placing a zinc layer on the interior surface may cause some additional issues with both resistance spot and stud welding, however, by using a very thin zinc layer, spot welding should be superior to that obtained by a typical, heavier galvanized coating while maintaining good corrosion resistance. The presence of thicker substantially pure zinc coatings during spot welding decreases weldability and promotes local delamination around spot welds. Spot weldability will be improved particularly when lower Zn—Al alloy coating weights can be used to achieve the desired corrosion performance.

A method for producing the laminate structure of this embodiment comprises starting with Zn—Al hot-dip coated skin sheet material, electro-galvanizing the coated sheet with zinc, and then laminating the resulting material using a viscoelastic core containing conductive particles.

In a second embodiment a laminate is produced that has steel skin sheets with Zn—Al alloy layers on both interior and exterior surfaces. A substantially pure zinc layer is located only on the laminate exterior surfaces. The laminate contains a viscoelastic core with conductive particles.

The resulting structure is shown in FIG. 3 looking at an edge portion (at location 2) of panel 10 of FIG. 1. In this embodiment, the panel 10 steel laminate comprises a first steel sheet 300 and a second steel sheet 302 that sandwich a viscoelastic polymer core layer 304 that is generally co-extensive with facing surfaces of steel sheets 300, 302. Again, it is seen that each steel sheet 300, 302 has a surface facing polymer core layer (termed an inner surface) and a surface opposite the core layer (termed an outer surface). And again polymer core 304 comprises dispersed conductive particles 306 to provide suitable electrical conductivity through the usually non-conductive core material and between the inner surfaces of the sheets.

Steel sheets 300, 302 are about 0.5 mm thick and polymer core layer 204 is about 0.04 mm thick. In various embodiments, each steel sheet 300, 302 may have the same thickness or different thickness.

In this embodiment, both inner and outer surfaces of both steel sheets 300, 302 are coated with a layer 308 of zinc-aluminum (95:5) alloy. Thus, laminate 10 comprises four zinc-aluminum alloy layers 308 each about 0.004 mm to about 0.012 mm thick. In various embodiments, each layer 308 may have the same thickness or different thickness. However, in this embodiment only the outer zinc-aluminum alloy layers 308 are coated with a thin zinc galvanized layer 310 about one micrometer thick. In various embodiments, each layer 310 may have the same thickness or different thickness. Thus, zinc galvanized layers 310 on the outside steel sheet faces of the panel laminate 10 are exposed to the panel environment. Zinc-aluminum alloy layers 308 on the inside steel sheet faces contact the polymer core layer 304 and conductive particles 306.

In this second embodiment the laminate would have the potential painting performance of galvanized steel sheet. The exterior zinc layer would also add lubricity for forming. In addition, the Zn—Al alloy layer on the interior surfaces should provide improved corrosion protection compared to a similar coating weight of substantially pure zinc. Finally, replacing substantially pure zinc at the interior surface with a Zn—Al alloy should help both resistance spot and stud welding performance, particularly if lower coating weights can be used to achieve the desired corrosion performance.

A suitable method to produce the coating layer combinations of this second embodiment laminate may be to use Zn—Al hot-dip coated skin sheet material to form a laminate. Next, the entire laminate may be electro-galvanized to provide a substantially pure zinc layer on the exterior surface.

In a third embodiment, a steel laminate is formed having steel skin sheets with completely different coatings on the interior and exterior surfaces. The laminate has a substantially pure zinc coating applied to the exterior surface and a Zn—Al alloy coating applied to the interior surface. The laminate is also made using a viscoelastic core that contains conductive particles. The resulting laminate is shown in FIG. 4 looking at an edge portion (at location 2) of panel 10 of FIG. 1.

In this embodiment, the panel 10 steel laminate comprises a first steel sheet 400, and a second steel sheet 402 (each may be about 0.5 mm thick) that sandwich a viscoelastic polymer core layer 404 that is generally co-extensive with facing surfaces of steel sheets 400, 402 and about 0.04 mm thick. In various embodiments, each steel sheet 400, 402 may have the same thickness or different thickness. Again, it is seen that each steel sheet 400, 402 has a surface facing polymer core layer (termed an inner surface) and a surface opposite the core layer (termed an outer surface). And again polymer core 404 comprises about one to about two percent by volume dispersed conductive particles 406 to provide suitable electrical conductivity through the usually non-conductive core material and between the inner surfaces of the sheets.

In this embodiment, only the inner surfaces of both steel sheets 400, 402 are coated with a layer 408 of zinc-aluminum alloy (for example, 95:5) that may be about 0.004 mm to about 0.012 mm in thickness. In various embodiments, each layer 408 may have the same thickness or different thickness. Thus, in this embodiment laminate 10 comprises only two zinc-aluminum alloy layers 408 on the inner faces of sheets 400, 402 and in contact with polymer core layer 404 and conductive particles 406. The outer faces of steel sheets 400, 402 are coated with relatively thick zinc galvanized layers 410 about 0.004 mm to about 0.015 mm (about four to fifteen micrometers) in thickness. In various embodiments, each layer 410 may have the same thickness or different thickness. Thus, zinc galvanized layers 410 on the outside steel sheet faces of the panel laminate 10 are exposed to the panel environment.

In this third embodiment, the substantially pure zinc exterior layer would provide the painting performance of galvanized steel sheet as well as good lubricity and resistance to surface cracking to enhance formability. The Zn—Al alloy layer on the interior surfaces provides improved corrosion protection compared to a similar coating weight of substantially pure zinc. Finally, elimination of pure zinc at the interior surface should benefit both resistance spot and drawn arc stud welding by reducing zinc vaporization, particularly if lower coating weights can be used to achieve the desired corrosion performance.

One method of producing this third embodiment of steel laminate would be to electrocoat a single side of the skin sheet material with a Zn—Al alloy. These skin sheets would be laminated together with the bare steel surfaces exposed. A substantially pure zinc layer would be applied to the exterior surfaces of the laminate by electro galvanizing.

And in a fourth embodiment of the invention, a zinc-aluminum alloy corrosion resistant coating, e.g., about four micrometers to about twelve micrometers thick, is applied to each of the intended inner steel sheet surfaces and to the intended outer sheet surfaces of the steel laminate. No substantially pure zinc coating is used in this embodiment. As in each of the above examples, the zinc-aluminum alloy may comprise, by weight, about two to six percent (even up to ten percent) aluminum, optionally about one to four percent magnesium, and the balance substantially all zinc.

A steel laminate in accordance with this fourth embodiment would have a cross-section like the laminate of FIG. 2 without the substantially pure zinc layers 210 or like the laminate of FIG. 3 without the substantially pure zinc layers 310. A steel laminate with two inner and two outer layers of zinc aluminum alloy would, for example, provide good corrosion resistance in applications where forming operations, joining operations, painting operations and the like are not encumbered by the aluminum content of any of the four zinc-aluminum alloy layers.

The invention has been illustrated by some specific embodiments but the scope of the invention is not limited to these examples.

1. A steel laminate article comprising:
first and second steel sheets facing and sandwiching a generally co-extensive core layer of viscoelastic polymer composition, the steel sheets having inner faces adjacent the core layer and opposing outer faces;
the inner face of one or both of the steel sheets being coated with a zinc-based alloy containing, by weight, about two to ten percent aluminum and, optionally, up to about four percent magnesium for corrosion resistance, the coated inner face being bonded to the polymer composition core layer; and
the outer face of at least one of the steel sheets being coated with at least one of the zinc-based alloy or substantially pure zinc.

2. A steel laminate article as recited in claim 1 in which the first and second steel sheets each have thicknesses in the range of about one half millimeter to about two millimeters and the core layer being thinner than either steel sheet and having a thickness up to about one-half millimeter.

3. A steel laminate article as recited in claim 1 in which the zinc-based alloy coating contains, by weight, about two to six percent aluminum and, optionally, up to about four percent magnesium for corrosion resistance.

4. A steel laminate article as recited in claim 1 in which the thickness of the zinc-based alloy coating is in the range of about two to about twenty micrometers.

5. A steel laminate article as recited in claim 1 in which both inner and outer faces of both steel sheets are coated with the zinc-based alloy.

6. A steel laminate article as recited in claim 5 in which the zinc-based alloy coatings on the outer faces of the laminate are coated with substantially pure zinc.

7. A steel laminate article as recited in claim 5 in which the zinc-based alloy coatings on the outer faces and on the inner faces of the laminate are coated with substantially pure zinc.

8. A steel laminate article as recited in claim 1 in which the inner faces of both steel sheets are coated with the zinc-based alloy.

9. A steel laminate article as recited in claim 1 in which the inner faces of both steel sheets are coated only with the zinc-based alloy and the outer faces of both steel sheets are coated only with substantially pure zinc.

10. A steel laminate article as recited in claim 9 in which the thickness of the substantially pure zinc coating is in the range of about four to about fifteen micrometers.

11. A steel laminate article as recited in claim 1 in which the outer face of at least one of the steel sheets is coated with substantially pure zinc and in which the thickness of the substantially pure zinc coating is in the range of about one to about twenty micrometers.

12. An automotive vehicle structure comprising a steel laminate panel, the steel laminate panel comprising:
first and second steel sheets facing and sandwiching a generally co-extensive core layer of viscoelastic polymer composition, the steel sheets having inner faces adjacent the core layer and opposing outer faces;
the inner face of at least one of the steel sheets being coated with at least one layer of a first zinc-based alloy chosen to permit welding of the steel laminate panel onto the automotive vehicle structure and to minimize long-term corrosion at the sheet/viscoelastic layer interface; and
the outer face of the steel sheets being coated with at least one layer of substantially pure zinc or a second zinc-based alloy chosen to provide compatibility with a high-voltage cathodic electrodeposition system while providing corrosion protection in the coated condition.

13. An automotive vehicle structure as recited in claim 12 in which the inner faces of both steel sheets are coated with the first zinc-based alloy comprising aluminum.

14. An automotive vehicle structure as recited in claim 13 in which the first zinc-based alloy further comprises magnesium.

15. An automotive vehicle structure as recited in claim 12 in which the inner faces of both sheets are first coated with the first zinc-based alloy comprising aluminum, which is in turn coated with substantially pure zinc.

16. An automotive vehicle structure as recited in claim 15 in which the first zinc-based alloy further comprises magnesium.

17. An automotive vehicle structure as recited in claim 12 in which the outer faces of both sheets are coated with substantially pure zinc.

18. An automotive vehicle structure as recited in claim 12 in which the outer faces of both sheets are coated with the second zinc-based alloy comprising aluminum.

19. An automotive vehicle structure as recited in claim 18 in which the second zinc-based alloy further comprises magnesium.

20. An automotive vehicle structure as recited in claim 12 in which the outer faces of both sheets are first coated with the second zinc-based alloy comprising aluminum, which is in turn coated with substantially pure zinc.
